(19) United States
(12) Patent Application Publication
(10) Pub. No.: US 2021/0066938 A1
(43) Pub. Date: Mar. 4, 2021

(54) POWER CONTROL DEVICE OF DRIVE VIDEO RECORD SYSTEM AND METHOD THEREOF

(71) Applicants: HYUNDAI MOTOR COMPANY, Seoul (KR); KIA MOTORS CORPORATION, Seoul (KR)

(72) Inventors: Dong Hyuk JEONG, Hwaseong-si (KR); Sang Lok SONG, Seoul (KR); Jae Uk KIM, Ulsan (KR); Sung Hwan JUN, Hwaseong-si (KR)

(73) Assignees: HYUNDAI MOTOR COMPANY, Seoul (KR); KIA MOTORS CORPORATION, Seoul (KR)

(21) Appl. No.: 16/824,009

(22) Filed: Mar. 19, 2020

(30) Foreign Application Priority Data
Aug. 29, 2019 (KR) 10-2019-0106761

(51) Int. Cl. H02J 7/00; H02J 7/34

(52) U.S. Cl. CPC H02J 7/0063; B60R 11/04; H02J 7/342; H02J 7/0048

(57) ABSTRACT

A power control device of a Drive Video Record System (DVRS) and a method controlling the DVRS may effectively use the electrical power of a secondary battery in addition to the electrical power of a main battery by controlling the operating power of the DVRS based on the state of charge (SoC) of the main battery and the SoC of the secondary battery while a power supply line from the main battery mounted in a vehicle and a power supply line from the secondary battery are implemented separately. The power control device of DVRS includes the main battery supplying the electrical power to electrical devices and the DVRS of a vehicle, the secondary battery supplying the electrical power to the DVRS, and a controller controlling the electrical power supplied to the DVRS based on the SoC of the main battery and the secondary battery.

### CROSS-REFERENCE TO RELATED APPLICATION

This application claims priority to and the benefit of Korean Patent Application No. 10-2019-0106761, on Aug. 29, 2019, the entire contents of which are incorporated herein by reference.

### FIELD

The present disclosure relates to a technology for controlling the power of Drive Video Record System (DVRS) that records a surrounding image, while the DVRS is mounted on a vehicle.

### BACKGROUND

The statements in this section merely provide background information related to the present disclosure and may not constitute prior art.

In general, a Drive Video Record System (DVRS) operates with power received from a secondary battery that is charged by a main battery that supplies power to an electrical device of a vehicle. Herein, the secondary battery is one of the electrical devices of the vehicle and has a power supply structure of main battery-secondary battery-DVRS.

When the vehicle is in a mode for supplying power to the electrical device of the vehicle (hereinafter, ACC ON mode), the DVRS determines that the engine of the vehicle is in operation and then the DVRS operates with power received from the secondary battery which is charged by the main battery supplying the starting power to the engine. When the vehicle is in a mode for not supplying power to the electrical device of the vehicle (hereinafter, ACC OFF mode), the DVRS determines that the engine is stopped, and operates with power received from a secondary battery, without charge by the main battery.

We have discovered that the conventional DVRS does not determine whether the engine of the vehicle stops and thus the secondary battery is charged by the main battery in the ACC OFF mode, such that the conventional DVRS may excessively discharge the main battery to the extent that the engine cannot be started by the main battery.

Furthermore, the conventional DVRS may not consider the State of Charge (SoC) of the main battery and the SoC of the secondary battery, and thus may not operate efficiently.

The matters described in this Background are intended to enhance the understanding of the background of the present disclosure and may include matters that are not the prior art already known to those of ordinary skill in the art.

### SUMMARY

An aspect of the present disclosure provides a power control device of DVRS that effectively uses the electrical power of a secondary battery in addition to the electrical power of a main battery by controlling the operating power of the DVRS based on the SoC of the main battery and the SoC of the secondary battery while a power supply line from the main battery mounted in a vehicle and a power supply line from the secondary battery are implemented separately, and a method thereof.

Objects of the present disclosure are not limited to the above-mentioned object, and other objects and advantages of the present disclosure that is not mentioned will be understood from the following description, and it will be apparently understood from exemplary forms of the present disclosure. In addition, it will be easily understood that the objects and advantages of the disclosure are realized by means and combinations described in the appended claims.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a power control device of DVRS may include: a main battery supplying electrical power to electrical devices and the DVRS, which are mounted in a vehicle; a secondary battery supplying electrical power to DVRS; and a controller configured to control the electrical power supplied to the DVRS based on a state of charge (SoC) of the main battery and a SoC of the secondary battery.

In some forms of the present disclosure, the controller may identify the SoC of the main battery through a first network in the vehicle, and may identify the SoC of the secondary battery through a second network in the vehicle. At this time, the first network may be a Controller Area Network (CAN), and the second network may be a Local Interconnect Network (LIN). Furthermore, the controller may provide fault information of the DVRS to a management module of the secondary battery via the LIN.

Moreover, the controller may supply the electrical power of the secondary battery to the DVRS during a setting time received from a user.

In some forms of the present disclosure, the controller may cut off the electrical power supply from the secondary battery to the DVRS, when receiving an interruption signal from the user before the setting time expires.

In another form, the controller may supply the electrical power of the main battery to the DVRS when the secondary battery is discharged before the setting time expires.

In other form, the controller may cut off the electrical power of the main battery supplied to the DVRS when a SoC value of the main battery is not greater than a reference SoC value.

In some forms of the present disclosure, the controller may allow the secondary battery to be charged by the electrical power of the main battery when an engine of the vehicle is operating, and may inhibit the secondary battery from being charged by the electrical power of the main battery when the engine of the vehicle is not operating.

In one form, the controller may allow the secondary battery to be charged by the electrical power of the main battery when a SoC value of the main battery exceeds a reference SoC value even though the engine of the vehicle is not operating.

According to an aspect of the present disclosure, a power control method of DVRS may include: identifying, by a controller, a state of charge (SoC) of a main battery configured to supply electrical power to electrical devices and the DVRS, which are mounted in a vehicle; identifying, by the controller, a SoC of a secondary battery configured to supply electrical power to DVRS; and controlling, by the controller, the electrical power supplied to the DVRS based on the SoC of the main battery and the SoC of the secondary battery.

In some forms of the present disclosure, identifying the SoC may include: identifying the SoC of the main battery through a first network in the vehicle, and identifying the SoC of the secondary battery through a second network in the vehicle. In one form, the first network may be a Controller Area Network (CAN), and the second network may be a Local Interconnect Network (LIN).

The method of the present disclosure may further include: providing, by the controller, fault information of the DVRS to a management module of the secondary battery via the LIN.

In some forms of the present disclosure, controlling the electrical power supplied to the DVRS may include supplying the electrical power of the secondary battery to the DVRS during a setting time received from a user.

In one form, controlling the electrical power supplied to the DVRS may include: when an interruption signal from the user is received before the setting time expires, cutting off the electrical power of the secondary battery supplied to the DVRS.

In another form, controlling the electrical power supplied to the DVRS may include: when the secondary battery is discharged before the setting time expires, supplying the electrical power of the main battery to the DVRS.

In other form, controlling the electrical power supplied to the DVRS may include: when a SoC value of the main battery is not greater than a reference SoC value, cutting off the electrical power of the main battery supplied to the DVRS.

In some forms of the present disclosure, identifying the SoC may include: allowing the secondary battery to be charged by the electrical power of the main battery when an engine of the vehicle is operating; and inhibiting the secondary battery from being charged by the electrical power of the main battery when the engine of the vehicle is not operating.

In another form, identifying the SoC may further include allowing the secondary battery to be charged by the electrical power of the main battery when a SoC value of the main battery exceeds a reference SoC value even though the engine of the vehicle is not operating.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram of a power control device of DVRS, according to one form of the present disclosure;

FIG. 2 is a flowchart illustrating a power control method of DVRS, according to one form of the present disclosure;

FIG. 3 is a flowchart illustrating a charging process of a secondary battery included in a power control device of DVRS, according to one form of the present disclosure; and

FIG. 4 is a block diagram illustrating a computing system for performing a power control method of DVRS, according to one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some forms of the present disclosure will be described in detail with reference to the exemplary drawings. In adding the reference numerals to the components of each drawing, it should be noted that the identical or equivalent component is designated by the identical numeral even when they are displayed on other drawings. Further, in describing the some forms of the present disclosure, a detailed description of well-known features or functions will be ruled out in order not to unnecessarily obscure the gist of the present disclosure.

In describing the components of the forms according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

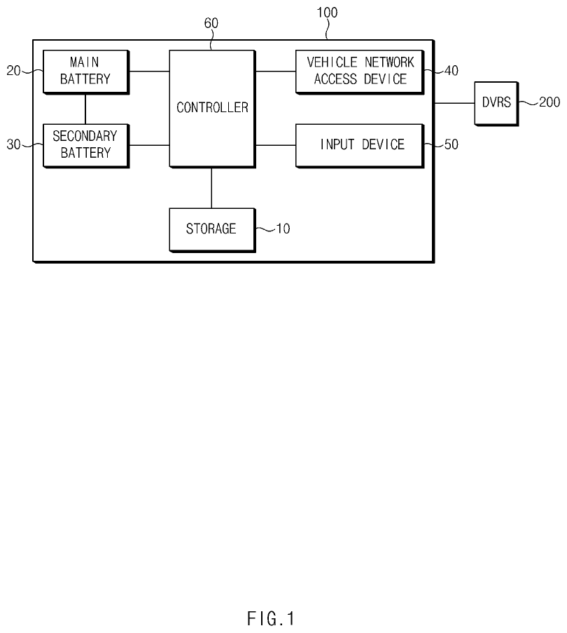

FIG. 1 is a block diagram of a power control device of DVRS, according to one form of the present disclosure.

As illustrated in FIG. 1, a power control device 100 of DVRS 200 may include: storage 10, a main battery 20, a secondary battery 30, a vehicle network access device 40, an input device 50, and a controller 60. In some forms of the present disclosure, according to a method of operating the power control device 100 of the DVRS 200, components of the power control device may be implemented as one device after being coupled with one another or a part of components may be omitted.

Referring to each of the components, first of all, the storage 10 may store various logics, algorithms, and programs required in a process of controlling the operating power of the DVRS 200 in consideration of the SoC of the main battery 20 and the SoC of the secondary battery 30.

The storage 10 may store a setting time entered from a user through the input device 50. At this time, the setting time indicates the time taken to capture the surrounding image of the vehicle in a state where the vehicle is parked (the state where the vehicle's engine is stopped).

The storage 10 may store a reference SoC value as a condition for stopping the charging of the secondary battery 30 by means of the main battery 20 in a state where the vehicle engine is stopped. At this time, for example, the reference SoC value may be 50% as the minimum charge level of the main battery 20 to allow a vehicle to start an engine.

The storage 10 may include at least one type of a storage medium among a flash memory type of a memory, a hard disk type of a memory, a micro type of a memory, and a card type (e.g., a Secure Digital (SD) card or an eXtream Digital (XD) Card) of a memory, a Random Access Memory (RAM) type of a memory, a Static RAM (SRAM) type of a memory, a Read-Only Memory (ROM) type of a memory, a Programmable ROM (PROM) type of a memory, an Electrically Erasable PROM (EEPROM) type of a memory, an Magnetic RAM (MRAM) type of a memory, a magnetic disk type of a memory, and an optical disc type of a memory.

The main battery 20 may be a battery that is mounted in the vehicle and supplies power to an electrical device in the vehicle; when the SoC value of the main battery 20 exceeds the reference SoC value, the main battery 20 may supply power to the DVRS 200 or the secondary battery 30, which is one of the electrical devices in the vehicle. At this time, the secondary battery 30 charged by the main battery 20 may supply the power the DVRS 200. Herein, when the main battery 20 has the capacity of 50 Ah, the reference SoC value may be 25 Ah, which is 50%.

The main battery 20 may have a first power supply line for supplying the power to the DVRS 200.

The secondary battery 30 supplies the power to the DVRS 200 in a state where the vehicle is parked, as a battery for supplying power to the DVRS 200. The secondary battery 30 may be charged by receiving a charging current from an alternator or the main battery 20 in the state where the engine of the vehicle operates. At this time, when the SoC value of the main battery 20 exceeds a reference SoC value in a state where the engine of the vehicle is stopped, the secondary battery 30 may receive power from the main battery 20 so as to be charged.

The secondary battery 30 may have a second power supply line for supplying power to the DVRS 200.

The vehicle network access device 40 is a module for accessing a vehicle network; and the controller 60 may obtain various pieces of information (data) through the vehicle network. Herein, the vehicle network includes Controller Area Network (CAN), Local Interconnect Network (LIN), FlexRay, Media Oriented Systems Transport (MOST), Ethernet, or the like.

For example, the controller 60 may obtain the engine operation information (ON/OFF) of the vehicle and the charging information of the main battery 20 via CAN, may obtain the charging information of the secondary battery 30 via LIN, and may also provide information related to faults that occurred in the DVRS 200 to a management module (not illustrated) of the secondary battery 30 via LIN. At this time, the management module of the secondary battery 30 that identifies the failure of the DVRS 200 may cut off the power supply to the DVRS 200, thereby preventing unnecessary energy waste.

The input device 50 may receive the setting time from the user and may also receive an operation interruption request of the DVRS 200 from the user. That is, the input device 50 may receive a request for interrupting the power to be supplied to the DVRS 200.

The controller 60 performs overall control such that each of the components is capable of normally performing functions of the components. The controller 60 may be implemented in the form of hardware, may be implemented in the form of software, or may be implemented in the form of the combination of hardware and software. Favorably, the controller 110 may be implemented as a microprocessor, but is not limited thereto.

In particular, the controller 60 may control the operating power of the DVRS 200 in consideration of the SoC of the main battery 20 and the SoC of the secondary battery 30. That is, the controller 60 may supply power to the DVRS 200 or may cut off the power supplied to the DVRS 200, by selectively using the main battery 20 and the secondary battery 30.

The controller 60 may obtain the operation information (ON/OFF) of the engine from the vehicle network via the vehicle network access device 40; in a state where the engine of the vehicle is stopped (the state where the vehicle is parked), the controller 60 may operate the DVRS 200 by receiving power from the secondary battery 30. At this time, the controller 60 may supply the secondary battery 30 power to the DVRS 200 during the setting time entered from the user through the input device 50.

Herein, when the controller 60 receives an interrupt signal from the user via the input device 50 in a situation where the setting time does not expire, the controller 60 may cut off the power of the secondary battery 30 supplied to the DVRS 200.

Furthermore, when the secondary battery 30 is discharged in a situation where the setting time does not expire, the controller 60 may cut off the power of the secondary battery 30 supplied to the DVRS 200.

Furthermore, when the secondary battery 30 is discharged in a state where the setting time does not expire, the controller 60 may supply the power of the main battery 20 to the DVRS 200. At this time, when the SoC value of the main battery 20 is not greater than the reference SoC value, the controller 60 may cut off the power of the main battery 20 supplied to the DVRS 200.

Furthermore, when the secondary battery 30 is discharged in a situation where the setting time does not expire, the controller 60 does not supply the power of the main battery 20 to the DVRS 200 at all, and thus may interrupt the DVRS 200 when the SoC value of the main battery 20 is not greater than the reference SoC value.

Furthermore, the controller 60 may selectively use the first power supply line and the second power supply line based on the state of the main battery 20 and the state of the secondary battery 30.

In the meantime, the controller 60 may obtain the operation information (ON/OFF) of the engine from the vehicle network through the vehicle network access device 40; when the engine is operating in the ACC ON state, the controller 60 allows the secondary battery 30 to be charged using the power of the main battery 20; however, when the engine is not operating in the ACC ON state, the controller 60 does not allow the secondary battery 30 to be charged using the power of the main battery 20. At this time, because the main battery 20 is charged by an alternator (not illustrated) when the engine of the vehicle is operating, the situation that the main battery 20 is not discharged does not occur even though the secondary battery 30 is charged using the power of the main battery 20.

Herein, when the SoC value of the main battery 20 exceeds the reference SoC value even though the engine is not operating in the ACC ON state, the controller 60 may allow the secondary battery 30 to be charged using the power of the main battery 20.

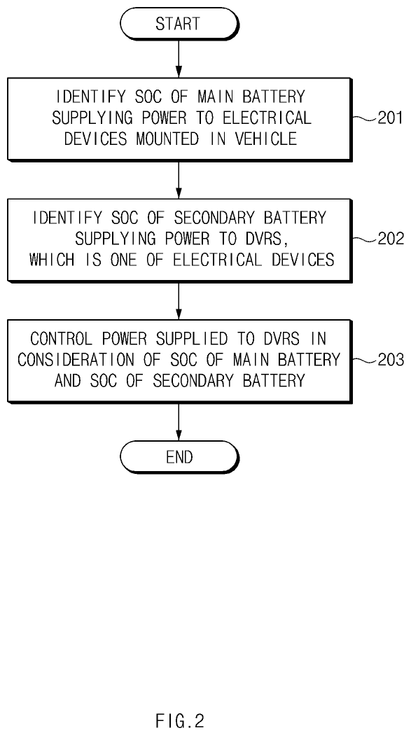

FIG. 2 is a flowchart illustrating a power control method of DVRS, according to one form of the present disclosure.

First of all, the controller 60 identifies the SoC of the main battery 20 that supplies electrical power to electrical devices mounted in a vehicle (201).

Furthermore, the controller 60 identifies the SoC of the secondary battery 30 that supplies electrical power to the DVRS 200, which is one of the electrical devices (202).

Afterward, the controller 60 controls the electrical power supplied to the DVRS 200 based on the SoC of the main battery 20 and the SoC of the secondary battery 30 (203).

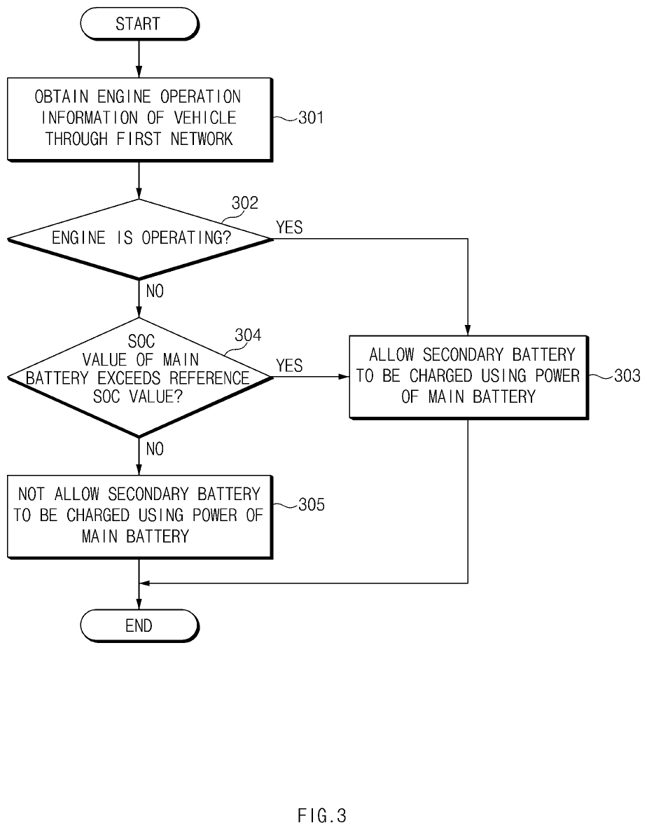

FIG. 3 is a flowchart illustrating a charging process of a secondary battery included in a power control device of DVRS, according to another form of the present disclosure.

First of all, the controller 60 obtains engine operation information (ON/OFF) of a vehicle through a first network (301).

Afterward, the controller 60 determines whether an engine of the vehicle is operating (302).

When the determination result (302) indicates that the engine of the vehicle is operating, the controller 60 allows the secondary battery 30 to be charged using the electrical power of the main battery 20 (303). At this time, the vehicle is in the ACC ON state.

When the determination result (302) indicates that the engine of the vehicle is not in operation, the controller 60 determines whether the SoC value of the main battery 20 exceeds the reference SoC value (304).

When the determination result (304) indicates that the SoC value of the main battery 20 exceeds the reference SoC value, the controller 60 proceeds to ‘303’.

When the determination result (304) indicates that the SoC value of the main battery 20 does not exceed the reference SoC value, the controller 60 may not allow the secondary battery 30 to be charged using the electrical power of the main battery 20 (305). In this case, the reference SOC value may be a value corresponding to the minimum voltage desired to start a vehicle engine.

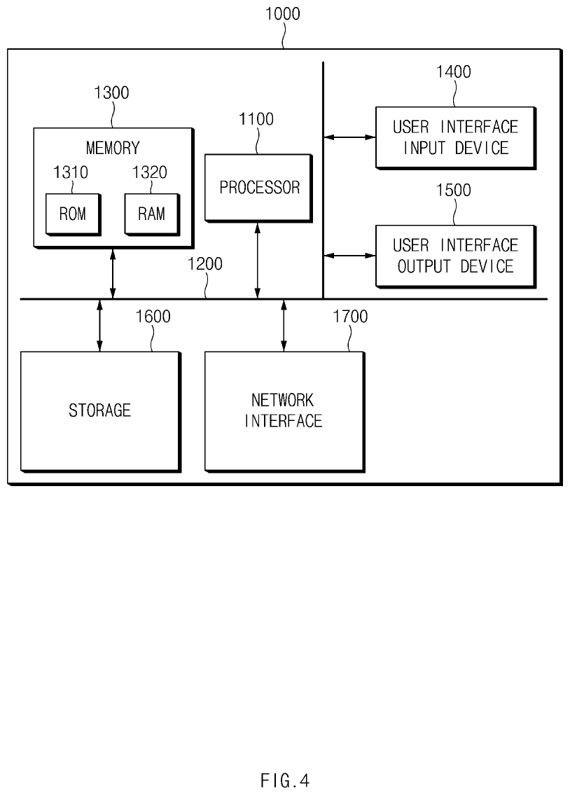

FIG. 4 is a block diagram illustrating a computing system for performing a power control method of DVRS, according to one form of the present disclosure.

Referring to FIG. 4, the power control method of DVRS may be implemented through the computing system. A computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Thus, the operations of the method or the algorithm described in connection with the some forms disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a Solid State Drive (SSD), a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

Therefore, the exemplary forms of the present disclosure are provided to explain the spirit and scope of the present disclosure, but not to limit them, so that the spirit and scope of the present disclosure is not limited by the foams. The scope of the present disclosure should be construed on the basis of the accompanying claims, and all the technical ideas within the scope equivalent to the claims should be included in the scope of the present disclosure.

According to the exemplary forms of the present disclosure, a power control device of DVRS and a method thereof may effectively use the power of a secondary battery in addition to the power of a main battery by controlling the operating power of the DVRS in consideration of the SoC of the main battery and the SoC of the secondary battery while a power supply line from the main battery mounted in a vehicle and a power supply line from the secondary battery are implemented separately.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

What is claimed is:

1. A power control device of a Drive Video Record System (DVRS), the power control device comprising:
a main battery configured to supply electrical power to electrical devices and the DVRS, which are mounted in a vehicle;
a secondary battery configured to supply electrical power to the DVRS; and
a controller configured to control the electrical power supplied to the DVRS based on a state of charge (SoC) of the main battery and a SoC of the secondary battery.

2. The power control device of claim 1, wherein the controller is configured to:
identify the SoC of the main battery through a first network in the vehicle, and
identify the SoC of the secondary battery through a second network in the vehicle.

3. The power control device of claim 2, wherein the first network is a Controller Area Network (CAN), and
wherein the second network is a Local Interconnect Network (LIN).

4. The power control device of claim 3, wherein the controller is configured to provide fault information of the DVRS to a management module of the secondary battery via the LIN.

5. The power control device of claim 1, wherein the controller is configured to supply the electrical power of the secondary battery to the DVRS during a setting time received from a user.

6. The power control device of claim 5, wherein when an interruption signal from the user is received before the setting time expires, the controller is configured to cut off electrical power supply from the secondary battery supplied to the DVRS.

7. The power control device of claim 5, wherein when the secondary battery is discharged before the setting time expires, the controller is configured to supply the electrical power of the main battery to the DVRS.

8. The power control device of claim 7, wherein when a SoC value of the main battery is not greater than a reference SoC value, the controller is configured to cut off electrical power supply from the main battery to the DVRS.

9. The power control device of claim 1, wherein the controller is configured to:
allow the secondary battery to be charged by the electrical power of the main battery when an engine of the vehicle is operating, and
when the engine of the vehicle is not operating, inhibit the secondary battery from being charged by the electrical power of the main battery.

10. The power control device of claim 9, wherein when a SoC value of the main battery exceeds a reference SoC value even though the engine of the vehicle is not operating, the controller is configured to allow the secondary battery to be charged by the electrical power of the main battery.

11. A power control method for a Drive Video Record System (DVRS), the power control method comprising:
identifying, by a controller, a state of charge (SoC) of a main battery configured to supply electrical power to electrical devices and the DVRS, which are mounted in a vehicle;
identifying, by the controller, a SoC of a secondary battery configured to supply electrical power to the DVRS; and
controlling, by the controller, the electrical power supplied to the DVRS based on the SoC of the main battery and the SoC of the secondary battery.

12. The power control method of claim 11, wherein identifying the SoC includes:
identifying the SoC of the main battery through a first network in the vehicle, and
identifying the SoC of the secondary battery through a second network in the vehicle.

13. The power control method of claim 12, wherein the first network is a Controller Area Network (CAN), and
wherein the second network is a Local Interconnect Network (LIN).

14. The power control method of claim 13, further comprising:
providing, by the controller, fault information of the DVRS to a management module of the secondary battery via the LIN.

15. The power control method of claim 11, wherein controlling the electrical power supplied to the DVRS includes:
supplying the electrical power of the secondary battery to the DVRS during a setting time received from a user.

16. The power control method of claim 15, wherein controlling the electrical power supplied to the DVRS includes:
when an interruption signal from the user is received before the setting time expires, cutting off the electrical power of the secondary battery supplied to the DVRS.

17. The power control method of claim 15, wherein controlling the electrical power supplied to the DVRS includes:
when the secondary battery is discharged before the setting time expires, supplying the electrical power of the main battery to the DVRS.

18. The power control method of claim 17, wherein controlling the electrical power supplied to the DVRS includes:
when a SoC value of the main battery is not greater than a reference SoC value, cutting off the electrical power of the main battery supplied to the DVRS.

19. The power control method of claim 11, wherein identifying the SoC includes:
when an engine of the vehicle is operating, allowing the secondary battery to be charged by the electrical power of the main battery; and
when the engine of the vehicle is not operating, inhibiting the secondary battery from being charged by the electrical power of the main battery.

20. The power control method of claim 19, wherein identifying the SoC further includes:
when a SoC value of the main battery exceeds a reference SoC value even though the engine of the vehicle is not operating, allowing the secondary battery to be charged by the electrical power of the main battery.
